(19) United States
(12) Patent Application Publication
(10) Pub. No.: US 2026/0148616 A1
(43) Pub. Date: May 28, 2026

(54) System and Method for Integrating Sports and Sport Betting

(71) Applicant: Andrew Grutka, Warminster, PA (US)

(72) Inventor: Andrew Grutka, Warminster, PA (US)

(21) Appl. No.: 19/178,179

(22) Filed: Apr. 14, 2025

Related U.S. Application Data
(60) Provisional application No. 63/696,518, filed on Sep. 19, 2024.

(51) Int. Cl. G07F 17/32

(52) U.S. Cl. CPC G07F 17/3288; G07F 17/3227; G07F 17/323; G07F 17/3241; G07F 17/3244; G07F 17/3276

(57) ABSTRACT

The present invention is a daily fantasy sports betting system that combines traditional sports betting and fantasy sports concepts into a single platform. The system includes a software application accessible via electronic devices or web browsers, enabling users to participate in daily sports betting tournaments. Users form sports betting lineups comprising predefined bet types, including spread bets, money line bets, over/under bets, parlay bets, and player prop bets, using an allocated virtual budget. The system hosts tournaments, calculates live bet outcomes, updates leaderboard rankings in real-time, and determines payouts based on user performance. The system incorporates an AI analytics engine for dynamic odds calculation, personalized recommendations, and payout management. A secure payment module facilitates entry fee processing and prize payouts. The user database stores user profiles, wallet balances, and transaction history and a payment module securely processing monetary transactions related to tournament entry fees and payouts.

### CROSS-REFERENCE TO RELATED APPLICATION

The present application claims priority to, and the benefit of, U.S. Provisional Application No. 63/696,518 which was filed on Sep. 19, 2024, and is incorporated herein by reference in its entirety

### FIELD OF THE INVENTION

The present invention generally relates to sports betting systems. More specifically, the invention relates to a daily fantasy sports betting system designed to combine traditional sports betting with fantasy sports concepts into a unified and competitive platform. The system comprises a user-facing software application installed on electronic devices, such as smartphones, for enabling users to register, select daily tournaments, form betting lineups, and track performance in real time. The system includes a user database for storing user profiles, betting history, and wallet balances, a ratings engine for evaluating player and team performance, and an AI analytics engine configured to dynamically calculate odds, personalize user recommendations, and determine payouts. Accordingly, the present disclosure makes specific reference thereto. Nonetheless, it is to be appreciated that aspects of the present invention are also equally applicable to other like applications, devices, and methods of manufacture.

### BACKGROUND

By way of background, traditional sports betting, where users place wagers on the outcomes of games or specific in-game events, has long been a popular activity for individuals. Sports betting is enjoyed by millions of individuals worldwide, particularly those who have a deep interest in sports. Simultaneously, fantasy sports have gained widespread popularity, enabling users to create their own teams of professional athletes and compete based on the real-life performance of those athletes. Conventionally, users'draft players, set lineups, and manage their teams over a season.

Despite the widespread popularity of both sports betting and fantasy sports, it is often difficult for users to find a platform that combines these two activities. Many sports enthusiasts may engage with one form of entertainment but not the other, thus missing out on opportunities to maximize their potential earnings. For instance, users who are fantasy sports players may avoid sports betting due to the complexity of traditional betting systems or the high level of risk involved. Conversely, those who are familiar with traditional sports betting may not explore fantasy sports, as it requires a different approach to engagement and long-term planning. Moreover, traditional daily fantasy sports platforms typically focus solely on fantasy team creation, player selections, and performance scoring, without incorporating elements of sports betting such as odds, spreads, or live wagering. Individuals desire an improved system and application that combines both fantasy sports and sports betting.

Therefore, there exists a long-felt need in the art for a daily fantasy sports betting system that combines the engagement of fantasy sports and traditional sports betting. There is a long-felt need for a system that enables users to participate in daily sports tournaments by forming betting lineups based on different types of bets while managing their virtual budgets. Additionally, there is a long-felt need in the art for a platform that simplifies betting for users by integrating fantasy-style gameplay with real-time sports wagering mechanics. Furthermore, there exists a need for a system that enables individuals to place bets on lineups rather than specific players. More specifically, there exists a long-felt need in the art for a system that includes varying entry fees from single digit bets to thousands of dollars bets that offer considerable payouts if bets are won. Finally, there is a long-felt need for a comprehensive platform that enhances user engagement, personalizes betting experiences using AI-based analytics, and provides secure payment processing for tournament entry fees and payouts.

The subject matter disclosed and claimed herein, in one embodiment, comprises a daily fantasy sports betting system designed to combine the principles of traditional sports betting and fantasy sports into a unified platform. The system includes a software application installed on an electronic device, such as a smartphone, enabling users to register, log in, and participate in daily sports tournaments. The system further includes a server system communicatively coupled to the software application via a communication network. The server system hosts tournaments, allocates virtual budgets to users, and facilitates the creation of sports betting lineups consisting of predefined bet types, including spread bets, money line bets, over/under bets, parlay bets, and player prop bets.

The system includes a user database configured to store user profiles, transaction histories, betting lineups, and wallet balances. A ratings engine evaluates player and team performance in real time based on live data and historical statistics. Additionally, the system incorporates an AI analytics engine that dynamically calculates odds, personalizes user recommendations based on betting habits, and determines payouts based on user performance in a tournament. A payment module enables secure transactions for entry fees and winnings using various payment methods, including credit cards and e-wallets.

In this manner, the daily fantasy sports betting system of the present invention accomplishes all of the foregoing objectives and provides an innovative solution to bridge the gap between fantasy sports and traditional sports betting. The system enables users to engage in competitive daily tournaments. The system integrates live performance tracking, real-time odds, and AI-driven personalization to enhance user engagement and enables users to make strategic betting decisions.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a daily fantasy sports betting system configured to combine traditional sports betting and fantasy sports concepts. The system includes a software application installed on an electronic device, wherein the software application enables users to create sports betting lineups and interact with the system. A server system is communicatively coupled to the software application via a communication network, the server system is configured to host daily sports betting tournaments with predefined rules, allocate a virtual budget to a user for forming a sports betting lineup including at least seven bets selected from the group consisting of a spread bet, a money line bet, an over bet, an under bet, a parlay bet, and two player prop bets, track the user's lineup performance in real time during the live tournament based on bet outcomes, and calculate a user's final ranking and payouts based on virtual winnings accumulated from the user's betting lineup.

In another aspect, the server system includes a user database for storing user profiles, wallet balances, betting history, and authentication credentials. An AI analytics engine is configured to dynamically calculate odds, personalize user experience, and determine payouts based on user performance. A payment module is integrated with the server system for secure processing of entry fees and payouts via a plurality of payment methods. A frontend engine provides responsive user interfaces to display tournament details, real-time tracking, leaderboards, and user notifications.

In another embodiment, a daily fantasy sports betting system is disclosed. The system includes a software application configured to provide an interface for users to register, authenticate, and place bets in daily tournaments, display live updates of user performance, virtual budget allocation, and leaderboard positions in real time. A server system is configured to receive a user's sports betting lineup consisting of seven bets, the lineup serving as a virtual wager within the tournament and calculate and update user rankings based on virtual winnings generated from the bet outcomes. A ratings engine generates ratings for teams and players based on performance metrics, playing conditions, and historical data.

In one embodiment, a method for conducting daily fantasy sports betting tournaments is described. The method includes the steps of registering a user and authenticating the user for access to a daily sports betting application, displaying a plurality of daily tournaments for different sports to the user, wherein each tournament includes predefined rules, entry fees, and prize pools, receiving a betting lineup from the user, the lineup including at least seven bets selected from a spread bet, a money line bet, an over bet, an under bet, a parlay bet, and two player prop bets, allocating a virtual budget to the user for placing the bets within the tournament, tracking the outcomes of the bets in real time during the tournament and updating the user's virtual winnings, calculating the user's final ranking based on the total virtual winnings achieved from the selected lineup, and providing payouts to the user based on the user's ranking and the preset rules of the tournament.

In still another aspect, a method for enabling users to participate in daily sports betting tournaments is described. The method includes the steps of hosting multiple daily tournaments on a server system, each tournament associated with an entry fee, a prize pool, and a set of betting rules, providing a software application on an electronic device for enabling users to register and log into the system and enabling users to create a betting lineup using a virtual budget allocated for the selected tournament. The method further includes receiving the betting lineup from the user, the lineup including seven or more bets, displaying real-time tracking of bet outcomes and leaderboard rankings during the live tournament, calculating a payout to the user based on the user's performance in the tournament and the rules associated with the prize pool, and securely processing the payout to the user's wallet through a payment module integrated into the system.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of daily fantasy sports betting system of the present invention in accordance with the disclosed architecture;

FIG. 2 illustrates a flow chart depicting a process of registration and onboarding of a user in the daily fantasy sports betting system in accordance with one embodiment of the present invention;

FIG. 3 illustrates a flow chart depicting a process of selection of a daily tournament by a user for placing bets in accordance with one embodiment of the present invention;

FIG. 4 illustrates a flow chart depicting a process of placing sports bets in a live tournament in accordance with one embodiment of the present invention;

FIG. 5 illustrates a flow chart depicting a process of paying out rewards or winning amounts to users in accordance with one embodiment of the present invention;

FIG. 6 illustrates an exemplary user interface displayed to a user when the user signs into the system in accordance with one embodiment of the present invention;

FIG. 7 illustrates an exemplary user interface for creating a sports betting lineup in accordance with one embodiment of the present invention; and

FIG. 8 illustrates a final ranking user interface for a tournament in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a daily fantasy sports betting system that combines the engagement of fantasy sports and traditional sports betting. There is a long-felt need for a system that enables users to participate in daily sports tournaments by forming betting lineups based on different types of bets while managing their virtual budgets. Additionally, there is a long-felt need in the art for a platform that simplifies betting for users by integrating fantasy-style gameplay with real-time sports wagering mechanics. Furthermore, there exists a need for a system that enables individuals to place bets on lineups rather than specific players. More specifically, there exists a long-felt need in the art for a system that includes varying entry fees from single digit bets to thousands of dollars bets that offer considerable payouts if bets are won. Finally, there is a long-felt need for a comprehensive platform that enhances user engagement, personalizes betting experiences using AI-based analytics, and provides secure payment processing for tournament entry fees and payouts.

The present invention, in one exemplary embodiment, is a daily fantasy sports betting system. The system includes a software application configured to provide an interface for users to register, authenticate, and place bets in daily tournaments, display live updates of user performance, virtual budget allocation, and leaderboard positions in real time. A server system is configured to receive a user's sports betting lineup consisting of seven bets, the lineup serving as a virtual wager within the tournament and calculate and update user rankings based on virtual winnings generated from the bet outcomes. A ratings engine generates ratings for teams and players based on performance metrics, playing conditions, and historical data. The system will also allow an individual to bet against another individual.

Reference will now be made in detail to the present preferred embodiments of the invention, examples of which are illustrated in the accompanying drawings. Wherever possible, the same reference numerals are used in the drawings and the description to refer to the same or like parts.

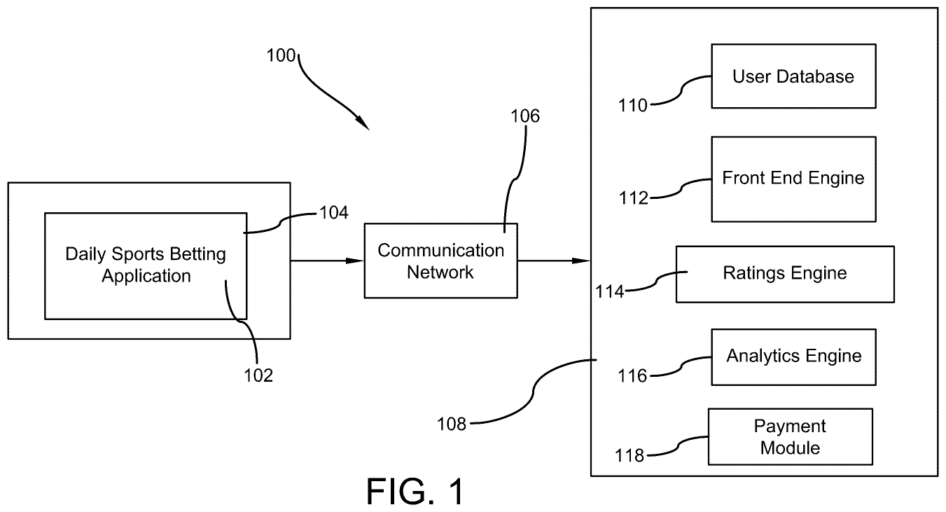

Referring initially to the drawings, FIG. 1 illustrates a schematic view of daily fantasy sports betting system of the present invention in accordance with the disclosed architecture. The daily fantasy sports betting system 100 of the present invention is configured to combine traditional sports betting and fantasy sports concepts into a single platform. The system 100 transforms fantasy sports into a sports betting environment and users form lineups which functions as “bets,” differing from traditional fantasy league formats where users pick players. The system 100 provides daily tournaments with predefined rules. Each tournament can have entry fees ranging from $1 to several thousand dollars enabling users to play with varied risk levels.

More specifically, the sports betting system 100 includes a software application 102 which is also referred to as daily sports betting application and is used by users for interacting with the system to place bets and earn rewards. The application 102 is configured to be installed in an electronic device 104 such as a smartphone. The system 100 may also be accessible using a website which runs on a web browser. A server system 108 provides the functionality for enabling the users to create lineups, place bets and compete in one or more tournaments. The application 102 and the server system 108 are coupled using a communication network 106 which can be a private or a public network such as internet.

A user database 110 stores user profiles, past transactions and line ups, and wallet balance information of users. The user database 110 is updated in real-time and is used for authenticating users for accessing the application 102. A frontend engine 112 provides different user interfaces in the application 102 for user interaction. The frontend engine 112 provides a responsive user interface that is compatible with different operating systems and mobile platforms. A ratings engine 114 is configured to calculate ratings for different players. The ratings engine includes information such as performance of the players and teams, ground and playing conditions to deduce a rating for each team and player during a live tournament.

An AI analytics engine 116 personalizes user experience based on betting habits and preferences of the users. The AI analytics engine 116 also uses predictive models for dynamic odds calculation. The engine 116 also determines payouts based on users'performance in a tournament according to the real-time bets of the tournament. A payment module 118 provides secure integration for entry fees and payouts. The payment module 118 supports a plurality of payment methods including but not limited to credit/debit cards, e-wallets, and more.

The server system 108 can be hosted on cloud platforms for scalability and high uptime. Further, the databases can be relational or non-relational databases. Also, all the information stored and transmitted to the server system 108 is encrypted for secure transmission and storage.

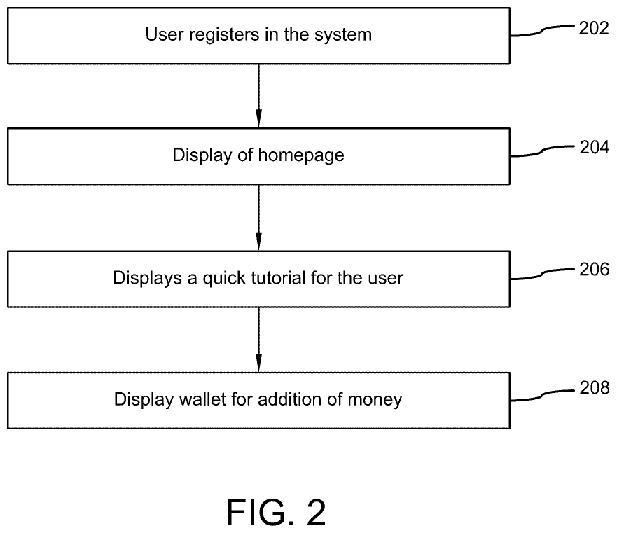

FIG. 2 illustrates a flow chart depicting a process of registration and onboarding of a user in the daily fantasy sports betting system in accordance with one embodiment of the present invention. Initially, a user who wants to play sport betting registers in the daily fantasy sports betting system 100 using the application 102 (Step 202). The user may need to upload age proof for authorization and create a user id and password during registration. Once the user successfully registers, a homepage is displayed to the user (Step 204). The homepage may display the name of the user and the current live tournaments available for the user to enroll in.

Thereafter, for the first time users, a quick tutorial explaining different features of the application 102 and the system 100 is displayed (Step 206). The tutorial can be in the form of a video, an A/V, or any other form. A wallet is displayed by the application 102 for enabling the user to add money to the wallet for placing bets in the application 102 (Step 208). The wallet can be recharged with any amount of money and using one or more payment methods including but not limited to credit cards, gift cards, and debit cards.

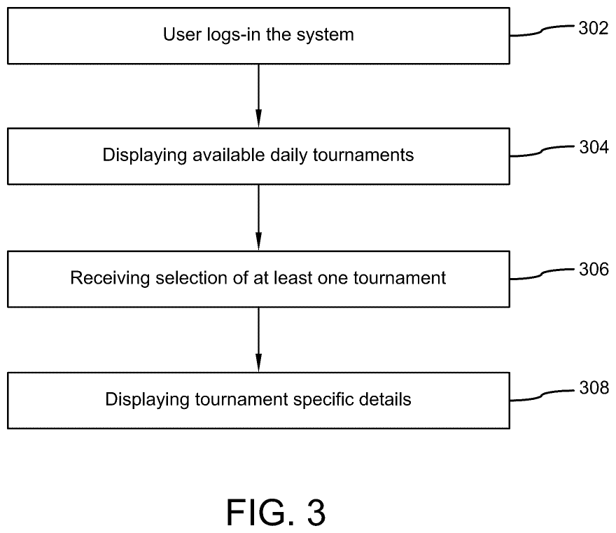

FIG. 3 illustrates a flow chart depicting a process of selection of a daily tournament by a user for placing bets in accordance with one embodiment of the present invention. Initially, a user logs into the system using the application 102 (Step 302). The user inputs the user ID and the password preset during the registration process for logging into the system 100. In some cases, biometric authentication such as fingerprint or face ID can also be used to log into the system. Once, the user successfully logs into the system, then, available daily tournaments for different sports are displayed in the application 102 (Step 304). The daily tournaments are updated in real time and may display information such as prize money and entry fees. Information such as an entry fee: $10, a prize pool: $2000, and a deadline: 2:00 PM may be displayed in the application for the tournaments.

Based on preferences of the user, the user may select one or more tournaments for placing bets (Step 306). In some embodiments, the user may place more than one bet in a tournament and can place bets in a plurality of tournaments simultaneously. Then, the application 102 displays the additional details such as number of users in the tournament, bets conditions, reward payout specification, and more for enabling the user to make an informed decision (Step 308).

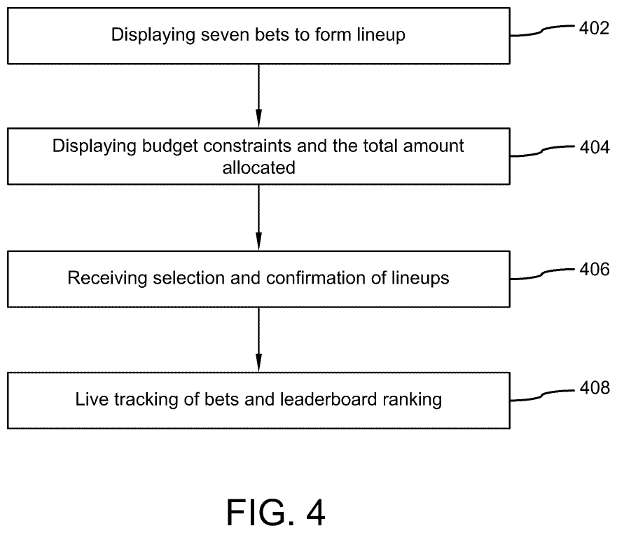

FIG. 4 illustrates a flow chart depicting a process of placing sports bets in a live tournament in accordance with one embodiment of the present invention. In continuation to FIG. 3, on selection of a tournament for placing bets, the seven bets to form sports betting lineups are displayed in the application (Step 402). It should be noted that in some embodiments, based on preferences of the users and game requirements, one or more additional bets may also be included to form the sports betting lineup. For each bet and the tournament, a budget constraint is displayed and the total amount allocated to the lineup is also updated and displayed in real-time (Step 404). Once at least one lineup is made for the tournament, selection and confirmation of the lineup are received from the user and the selected lineups become a part of the tournament betting (Step 406). Once the tournament starts, live tracking of bets is done by the system 100 and is displayed in the application 102 (Step 408). Also, leaderboard ranks are also calculated and updated in real-time.

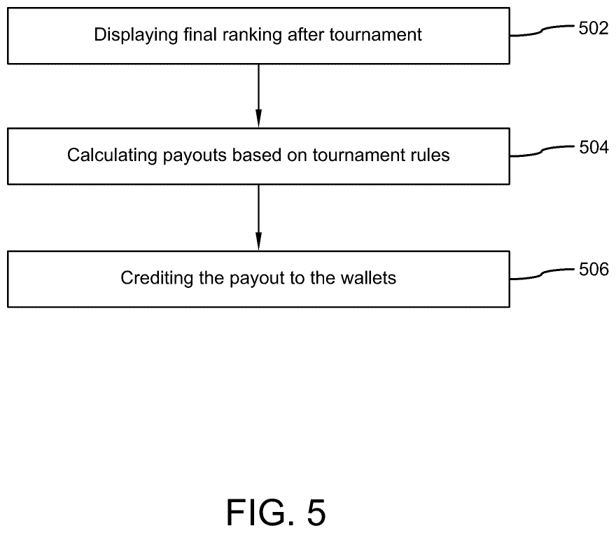

FIG. 5 illustrates a flow chart depicting a process of paying out rewards or winning amounts to users in accordance with one embodiment of the present invention. When a tournament finishes, the final rankings of the users based on score of their betting lineups are calculated, reviewed, and are displayed to all the users who placed bets in the tournament (Step 502). Accordingly, payouts from the total prize money of the tournament are provided to the winning users wherein the division of the payout is based on preset rules of the tournament (Step 504). Finally, the calculated payout is provided to each winning user in their wallets from where the amount can be withdrawn (Step 506).

In the preferred embodiment, the daily fantasy sports betting system 100 provides seven bets. The seven bets include a ‘spread bet’ which is related to predicting the margin of victory of a game. A ‘money line bet’ is related to choosing the winner of a game. An ‘over bet’ is a bet that the total score in a match will exceed a set threshold. An under bet is a bet that the total score will stay below a set threshold. A parlay bet combines multiple bets into one for higher risk and reward. Player prop bets is a bet on an individual player's performance such as a touchdown.

In one non-limiting example of the present invention, if a user chooses $5 entry fee tournament, then, the system may provide the user a virtual budget of $1,000 to place the bets. The user builds the lineup which may include the following

An exemplary spread bet can include the user betting $150 that the Dallas Cowboys will win by more than 4 points against the Green Bay Packers.

An exemplary ‘money line bet’ can include the user betting $200 on the Kansas City Chiefs to win outright against the Raiders.

An exemplary ‘over bet’ can include the user betting $100 that the Lakers vs. Celtics game will have a total score over 200 points.

An exemplary ‘under bet’ can include the user betting $100 that the Knicks vs. Heat game will have a total score under 300 points.

An exemplary ‘parlay bet’ can include the user betting $100 combining two or more outcomes: (1) Cowboys win outright, (2) Chiefs score over 23 points.

An exemplary ‘player prop bet 1’ can include the user betting $200 that Patrick Mahomes will throw for more than 250 yards.

An exemplary ‘player prop bet 2’ can include the user betting $150 that ABC player will score more than 35 points.

As the games take place, the daily fantasy sports betting system 100 tracks the lineup's performance in real time. If a bet wins, the virtual balance of the user increases based on the odds. If a bet loses, the bet amount is deducted from his virtual budget. Based on the odds, the virtual winnings of the user may be $1,800 and gets the fourth position and the top score in the tournament is $2,200. Accordingly, the top 3 players win the largest payouts and the user gets smaller prize. The odds for each tournament can be designed in real-time by the system and can also be preset for different sports.

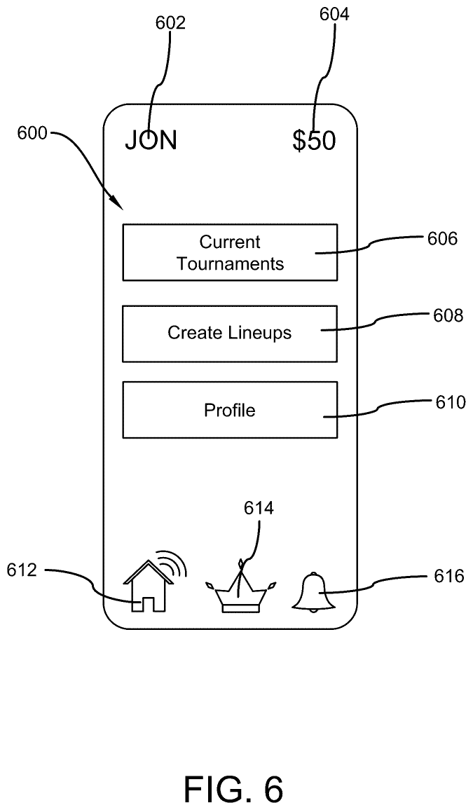

FIG. 6 illustrates an exemplary user interface displayed to a user when the user signs into the system in accordance with one embodiment of the present invention. As illustrated, the interface 600 displays the user name 602 and the current wallet balance 604. The interface 600 also displays a current tournaments tab 606 which when selected displays a plurality of active tournaments. A create lineups tab 608 enables the user to create different lineups for different tournaments and sports. A profile tab 610 enables the user to update the profile including preferences for creating lineups.

The footnote of the interface 600 displays a home icon 612 for displaying the basic information of the user. A leadership icon 614 when selected displays the leaders of different live tournaments of the system 100. A notification icon 616 is configured to display a plurality of personalized notifications to the user.

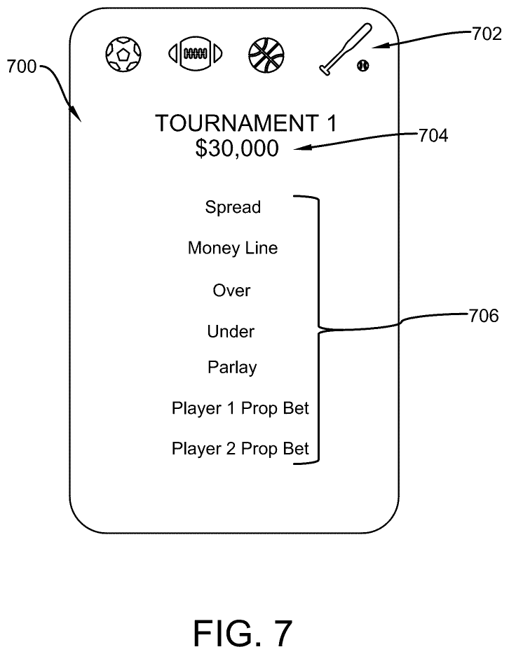

FIG. 7 illustrates an exemplary user interface for creating a sports betting lineup in accordance with one embodiment of the present invention. The interface 700 displays a plurality of sports icons 702 representing different sports which are supported by the system 100. Tournaments for different sports are available for betting in the system. As illustrated, a specific tournament ‘Tournament 1’ is selected and displayed for creating lineup. Total prize money 704 of the tournament is also displayed in the interface 700. A plurality of available bets 706 is included in the interface 700 and a user can create a lineup by using virtual money allocated for the tournament as described earlier in the disclosure.

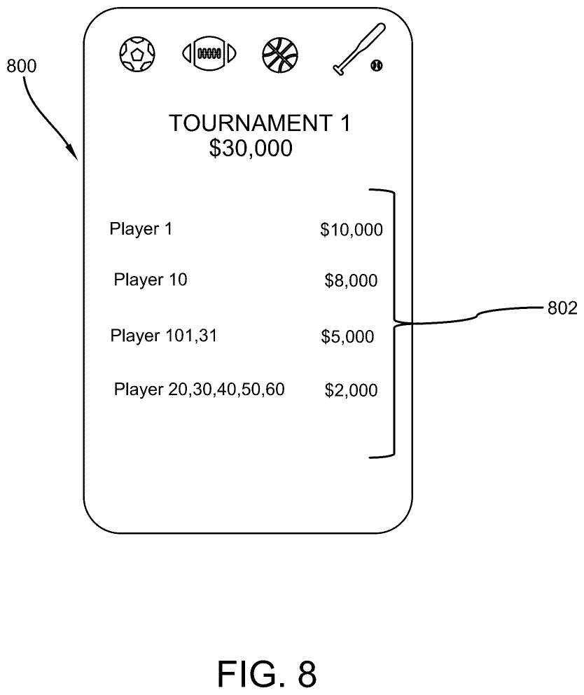

FIG. 8 illustrates a final ranking user interface for a tournament in accordance with one embodiment of the present invention. As illustrated, the interface 800 displays the winners 802 of the tournament ‘Tournament 1’. As illustrated, the prize money of the tournament is divided among the top leaders or winners of the tournament. It should be noted that players win the betting based on the wins against the odds.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “daily fantasy sports betting system”, “system and method for integrating fantasy sports and sports betting”, “sports betting system”, and “system” are interchangeable and refer to the system and method for integrating fantasy sports and sports betting 100 of the present invention.

Notwithstanding the forgoing, the system and method for integrating fantasy sports and sports betting 100 of the present invention can be of any suitable size and configuration as is known in the art without affecting the overall concept of the invention, provided that it accomplishes the above stated objectives. One of ordinary skill in the art will appreciate that the system and method for integrating fantasy sports and sports betting 100 as shown in the FIGS. are for illustrative purposes only, and that many other configurations of the system and method for integrating fantasy sports and sports betting 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A betting system comprising:
a mobile application having a daily sports betting application;
an electronic device;
a user database;
a plurality of users;
a server system;
a communication network; and
a ratings engine;
wherein said mobile application installed on said electronic device;
wherein said server system having a plurality of functionality selected from one or more of the group consisting of creating lineups, placing bets, and competing in tournaments;
wherein said daily sports betting application coupled to said server system with said communication network;
wherein said communication network selected from the group consisting of a private network and a public network;
wherein said user database stores information selected from one or more of the group consisting of a user profile, a past transaction, a line up, and a user wallet balance;
wherein said user database is updated in real-time; and
further wherein said ratings engine calculates ratings for different players based on information selected from the group consisting of a performance of a player, a performance of a team, and a playing condition.

2. The betting system of claim 1, wherein said user database is used for authenticating said plurality of users for accessing said mobile application.

3. The betting system of claim 2, wherein said electronic device is a smartphone.

4. The betting system of claim 2, wherein said electronic device is a website having a web browser.

5. The betting system of claim 1 further comprising an AI analytics engine, wherein said AI analytics engine personalizes user experience based on actions of said plurality of users selected from the group consisting of a betting habit and a betting preference.

6. The betting system of claim 5, wherein said AI analytics engine having dynamic odds calculation for determining payouts based on said plurality of users'performance in said tournament.

7. The betting system of claim 6 further comprising a payment module, wherein said payment module having payments selected from the group consisting of an entry fee and a payout.

8. The betting system of claim 7, wherein said payment of said payment module is selected from the group consisting of a credit payment, a debit card payment, a gift card payment, and an e-wallet payment.

9. The betting system of claim 8, wherein said payment module accepts additions to said user wallet balance, and further wherein said user wallet balance provides payments for said placing bets.

10. The betting system of claim 9, wherein said competing in tournaments includes information selected from the group consisting of a sport, a prize money, an entry fee, and a deadline.

11. The betting system of claim 10, wherein said daily sports betting application displays information selected from the group consisting of a number of users in said tournament, a betting condition, and a reward payout specification.

12. The betting system of claim 10, wherein said daily sports betting application having a plurality of betting options selected from one or more of the group consisting of a spread bet, a money line bet, an over bet, an under bet, a parlay bet, a first player prop bet, and a second player prop bet.

13. A betting system comprising:
a mobile application having a daily sports betting application;
an electronic device;
a user database;
a plurality of users;
a server system; and
a communication network;
wherein said mobile application installed on said electronic device;
wherein said server system having a plurality of functionality selected from one or more of the group consisting of creating lineups, placing bets, and competing in tournaments;
wherein said daily sports betting application coupled to said server system with said communication network;
wherein said communication network selected from the group consisting of a private network and a public network;
wherein said user database stores information selected from one or more of the group consisting of a user profile, a past transaction, a line up, and a user wallet balance;
wherein said user database is updated in real-time; and
further wherein said daily sports betting application having a plurality of betting options selected from one or more of the group consisting of a spread bet, a money line bet, an over bet, an under bet, a parlay bet, a first player prop bet, and a second player prop bet.

14. The betting system of claim 13, wherein said user database is used for authenticating said plurality of users for accessing said mobile application.

15. The betting system of claim 13 further comprising an AI analytics engine, wherein said AI analytics engine personalizes user experience based on actions of said plurality of users selected from the group consisting of a betting habit and a betting preference.

16. The betting system of claim 15, wherein said AI analytics engine having dynamic odds calculation for determining payouts based on said plurality of users'performance in said tournament.

17. The betting system of claim 13 further comprising a payment module, wherein said payment module having payments selected from the group consisting of an entry fee and a payout, and further wherein said payment of said payment module is selected from the group consisting of a credit payment, a debit card payment, a gift card payment, and an e-wallet payment.

18. The betting system of claim 17, wherein said payment module accepts additions to said user wallet balance, and further wherein said user wallet balance provides payments for said placing bets.

19. The betting system of claim 13, wherein said daily sports betting application displays information selected from the group consisting of a number of users in said tournament, a betting condition, a reward payout specification, a performance of a player, a performance of a team, and a playing condition.

20. A betting system comprising:
a mobile application having a daily sports betting application;
an electronic device;
a user database;
a plurality of users;
a server system; and
a communication network;
wherein said mobile application installed on said electronic device;
wherein said server system having a plurality of functionality selected from one or more of the group consisting of creating lineups, placing bets, and competing in tournaments;
wherein said daily sports betting application coupled to said server system with said communication network;
wherein said user database stores information selected from one or more of the group consisting of a user profile, a past transaction, a line up, and a user wallet balance;
wherein said user database is updated in real-time;
wherein said daily sports betting application having a plurality of betting options selected from one or more of the group consisting of a spread bet, a money line bet, an over bet, an under bet, a parlay bet, a first player prop bet, and a second player prop bet; and
further wherein said daily sport betting application having a payout module including a winning payout based on one or more of the group consisting of a final ranking of said plurality of users, a score of a betting lineup, a total prize money of said tournament, a preset rule of said tournament.
